(19) United States
(12) Patent Application Publication
(10) Pub. No.: US 2013/0270948 A1
(43) Pub. Date: Oct. 17, 2013

(54) ELECTRIC MOTOR HAVING OPTIMISED STATOR STRUCTURE

(71) Applicant: Valentin Unterfrauner, Munchen (DE)

(72) Inventor: Valentin Unterfrauner, Munchen (DE)

(73) Assignee: CPM COMPACT POWER MOTORS GMBH, Unterfohring (DE)

(21) Appl. No.: 13/994,993

(22) PCT Filed: Dec. 15, 2011
(86) PCT No.: PCT/EP2011/006344

§ 371 Date: Jun. 17, 2013

(30) Foreign Application Priority Data
Dec. 17, 2010 (DE) 102010055030.2

(51) Int. Cl. H02K 16/02

(52) U.S. Cl. CPC H02K 16/02
USPC 310/114

(57) ABSTRACT

The invention relates to an electric motor having a rotor and a hollow-cylindrical stator which carries exciter coils (3), the stator being connected at the end face to a stator carrier (8) of the electric motor and having stator teeth (1) which extend in an axial direction and which each have at least one pole shoe (1a, 1b), at least one coil winding (3) being wound around a stator tooth (1) in each case, there being arranged at one or both end faces (1_{St1}, 1_{St2}) of a stator tooth (1) and/or the pole shoes (1a, 1b) thereof an end face element (2, 6) which is/are at least partially wrapped or surrounded by the coil winding (3).

The present invention relates to an electric motor having a rotor and a hollow-cylindrical stator which carries exciter coils, the stator being connected at the end face to a stator carrier of the electric motor and having stator teeth which extend in an axial direction and which each have at least one pole shoe, at least one coil winding being wound around a stator tooth in each case.

### PRIOR ART

Electric motors which comprise a dual rotor in order to improve the magnetic circuit are known. These motors constitute a combination of an external rotor and an internal rotor. The stator comprises yokes which are surrounded by windings and which each have a radially inner and an outer pole face. A dual rotor has an external rotor and internal rotor, which are provided with permanent magnets. The dual rotor comprises the cylindrically constructed stator. The magnetic field produced in the yoke flows through the permanent magnets of the external and internal rotor, whereby the efficiency in terms of torque per unit current flow is increased. Such motors are previously known from WO2004/004098A1 and WO2006/083097A2.

The stator structure is heavily loaded owing to the magnetic interaction between the magnets and the stator. The torque which the rotor produces is produced from a tangential force between the stator teeth and the permanent magnets. This is not distributed in a uniform manner over all the teeth but instead is concentrated on individual stator teeth depending on the rotor position and current feed. The tangential force on an individual stator tooth consequently fluctuates several times per rotor rotation between a positive and a negative maximum value. In addition, a radial force is also produced between the stator teeth and the permanent magnets. This is at a maximum when the magnet is located directly centrally above the pole shoe. The radial force on an individual tooth consequently increases per rotor rotation several times from zero to a maximum value. The maximum forces do not occur in a uniform manner at all stator teeth, but instead have a time offset relative to each other, whereby an increasing pulsation occurs.

Motors having a dual rotor further have the problem that the stator is in principle arranged in a self-supporting manner between the external and internal rotor of the dual rotor. The stator teeth cannot be connected directly to each other by means of the stator plate since the teeth in an outward and inward direction have a pole shoe with respect to the respective permanent magnets. Consequently, the stator teeth cannot be supported directly on each other. A degree of strength can be achieved in that the entire stator is cast, whereby the individual teeth are connected to each other. Nonetheless, the cast member may only transmit forces in a limited manner. Specifically, supporting the stator teeth on the stator carrier is difficult since the winding on the coil limits the possibilities for solid connection.

In addition, in motors in which plastics material has a significant carrying function, the life-time is reduced when load cycles with changing temperatures are operated. These lead to accelerated ageing of the plastics materials, which can become evident with formation of cracks or reduction of the permissible loads, which can lead to a failure of the stator.

It is further disadvantageous that the casting operation excludes the possibility of cooling the stator in an active manner through forced air flow between the coils.

A dual rotor motor is described in WO2006/083097A2. In this dual rotor motor, the individual wound stator teeth are completely cast. The cast member has reinforcement ribs in order to improve the structure. However, this concept is only suitable for short stators having correspondingly low forces and low operating temperatures. The loads, particularly with high operating temperatures, would first lead to a settling effect and in the long term to the failure of the plastics material structure. In addition, a great air gap between the stator and rotor must be provided in order to compensate for the higher thermal expansion of the plastics material. However, a great air gap impairs the relationship between the current and torque and consequently the level of efficiency of the motor.

WO2004/004098A1 discloses a stator of a dual rotor motor in which, in addition to the cast member, the individual teeth are placed into a stator carrier plate with positive-locking elements before the casting operation. Consequently, a degree of tangential force can be transmitted. Since the axial structural space is limited in this dual rotor motor and the stator is accordingly short, the casting operation is sufficient for reinforcement. In motors with axially longer stators and greater torques, however, this stator structure is no longer adequate. In addition, the stator carrier plate cannot be produced from a material with a high level of thermal conductivity, such as, for example, aluminium, in a cost-effective manner since the positive-locking elements must have a high degree of precision. If the stator carrier plate is produced from plastics material, for example, in an injection-moulding method, the thermal conductivity and consequently the cooling of the stator is greatly limited, which leads to limited continuous output of the motor.

An object of the present invention is to develop the stator structure of a dual rotor motor in such a manner that greater axial stator lengths with a correspondingly higher torque and higher power class than before are possible.

This object is advantageously achieved with an electric motor having the features of claim 1. Advantageous embodiments of the electric motor and its stator structure according to claim 1 will be appreciated from the features of the dependent claims.

The stator structure comprises an assembly of stator teeth, surrounded end face elements which are arranged at the end face of the stator teeth and peripheral rings and coil windings.

In a preferred embodiment, U-shaped end face elements are fitted to each stator tooth at the two end faces thereof. When the stator teeth are surrounded by the coil, those elements are pressed against the stator tooth by means of the windings. Owing to a corresponding geometric structure, the end face elements produce a wide support base for the stator teeth so that the tangential and radial forces can be directed from the stator tooth firmly into the end face elements. It is now possible to connect all the stator teeth at the self-supporting stator side by means of a peripheral ring or to the stator carrier so that, as will be described in detail below, the forces which act on the teeth can be directed therein.

However, surrounding the end face elements by means of the coil windings also results in the forces being introduced into the coils so that they become part of the carrying structure. Since the copper wires may be located far outside the stator centre axis, the tensile and compression strains which arise owing to the tangential and radial forces can be absorbed in an optimum manner. The individual coil layers may additionally be bonded by using coils with baking lacquer insulation. However, since there is a high friction force between the coil wires owing to the wire tension during winding, particularly in the winding head, this is not absolutely necessary.

Additional peripheral rings may be fitted to the end face elements. These have positive effects for the structural strength, which are particularly evident at the self-supporting stator side. On the one hand, the radial forces which are very different depending on the rotor position on the stator teeth can be distributed in a uniform manner over the stator teeth. The ring acts as an arch for the radial forces so that on the whole they compensate for each other.

Furthermore, the tangential forces, which fluctuate strongly for each stator tooth depending on the rotor position between a positive and negative maximum value, are distributed by the peripheral ring over all the stator teeth. However, in this instance the forces do not compensate for each other but instead produce a torsion torque which is distributed over all the stator teeth so that the loading of the individual stator teeth is significantly lower than with an embodiment without a ring.

As a third effect, the combination of the ring and end face element, in the event of tangential loads of the stator teeth including at the self-supporting stator side, produces a support torque at the stator teeth which acts counter to the bending action so that the bending line of the stator teeth does not correspond to that of a self-supporting bar, but instead that of a bar having support torque at the free end. Consequently, in the event of specific loading, a smaller displacement is achieved.

In order to achieve the most stable construction possible, the end face elements are supported at one or both end sides of the stator tooth and/or the pole shoe(s) thereof. They are also wrapped or are surrounded by the coil winding and consequently press the end face elements securely against the stator tooth or the pole shoe thereof. In addition to securing the end face elements by means of the coil winding, the end face elements can be secured to the stator tooth by means of bonding or welding.

The end-face elements are advantageously U-shaped and have two side walls which are connected to each other by means of a connection wall. The connection wall also receives windings. In addition, the abutment face of the end face element may be adapted to the structure of the end face and/or the pole shoe in such a manner that a positive-locking engagement which acts in a radial direction and/or peripheral direction is produced. Thus, the end face of the stator tooth may have a projection which is surrounded laterally by formations of the end face element. It is also possible for at least one axial projection of the end face element to engage in a corresponding number of recesses of the end face of the stator tooth or the pole shoes thereof.

An insulation must be fitted between the coils and the support plates in order to prevent electrical short-circuits. These may preferably be constructed as paper insulation or as an injected plastics material member. It is also possible to apply an insulation layer directly to the end face element, for example, by means of powder coating. Paper insulation, in comparison with a plastics material member, has the advantage that it is thinner, has a higher permissible surface pressure and a higher permissible temperature. However, since the pressure load with respect to the effective surface-area is small, the loading is also permissible for the plastics material insulation member.

In addition to the measures described, the stator may additionally be cast. The strength which was already high in any case is advantageously thereby further increased.

Plastics materials generally have the property that the strength and consequently the permissible loading decreases as the temperature increases. Consequently, in motors in which plastics material performs a significant carrying function, a high-strength and temperature-resistant plastics material must be used. With the stator structure of the present invention, the plastics materials which are used are not subjected to any high loads.

Consequently, higher temperature and consequently load peaks are permissible or more favourable plastics materials are intended to be used. An ageing of the plastics material owing to environmental influences or frequent temperature load change is also not critical.

In addition to the improved strength of the stator structure, owing to the described concept the thermal dissipation from the stator and consequently the permissible peaks and the continuous power of the motor can also be improved. As described, the end face elements, which are located directly in the winding head, are connected directly to the stator carrier. A water circuit is preferably integrated in the stator carrier. Since the end face elements can be constructed from a material having a high level of thermal conductivity, such as, for example, steel, stainless steel, aluminium or copper, a comparatively high level of thermal conductivity can be achieved.

Different embodiments of the stator structure according to the invention are illustrated below with reference to drawings, in which:

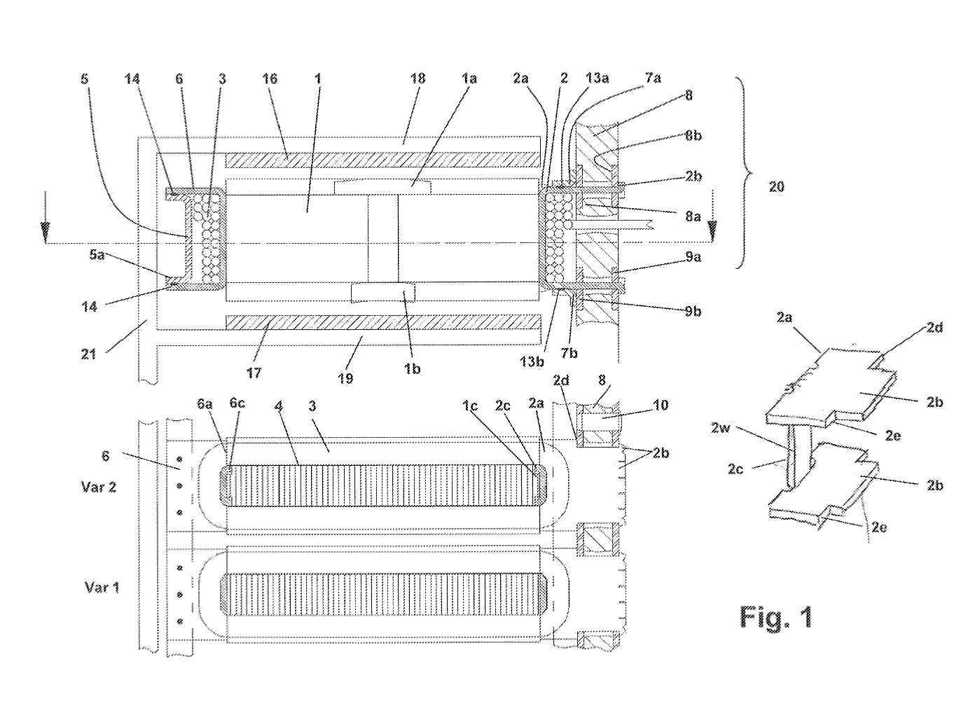

FIG. 1: shows two views of the stator structure for two different embodiments;

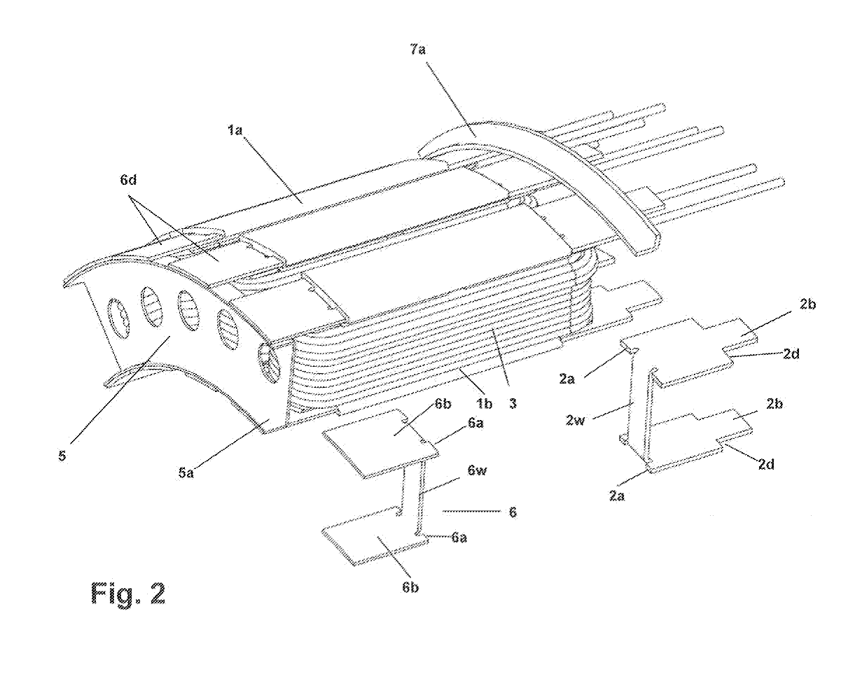

FIG. 2: is a three-dimensional view of the stator and the individually illustrated end face elements.

FIG. 1 shows two views of the dual rotor motor having the motor of the stator structure according to the invention. The lower view shows two possible embodiments of the stator.

The electric motor has a self-supporting stator 20 which is arranged between the external rotor 18 and the internal rotor 19. The external rotor 18 and the internal rotor 19 are connected to each other and to the shaft which is not illustrated by means of the base wall 21. The external and internal magnets 16, 17 are secured to the external rotor 18 and the internal rotor 19.

The stator structure substantially comprises an assembly of stator teeth 1, and the end face elements 2, 6 which are fitted thereto at the end face and which are surrounded by means of the coils 3 and are secured to the respective stator tooth 1. By means of peripheral rings 5, 7a, 7b, the end face elements 2 and 6 and consequently also the stator teeth 1 are connected to each other, respectively.

The structure of a stator tooth 1 is first described below.

The end face elements 2 and 6 are each positioned at the end face on an individual stator tooth 1. Subsequently, an insulation 4 is fitted. This may preferably be constructed as paper which is wound around the stator tooth 1 or an insulation member which is placed at both sides on the stator teeth 1. This assembly is now surrounded by the coil 3. The wire tensile force which is applied during winding ensures that the end face elements 2 and 6 are pressed firmly against the stator tooth 1. The end face elements 2, 6 have lateral elements 2a and 6a which extend as widely as possible over the pole shoes 1a and 1b and consequently form a wide support base between the stator tooth 1 and the end face elements 2, 6. Furthermore, there may be formed on the end face elements 2, 6 additional deformations 2c or 6c which are additionally supported at correspondingly recessed end locations or projections is of the stator tooth 1. Consequently, a curvature is produced for the coil 3, which is advantageous for the winding process.

Owing to the end face elements 2 and 6 being surrounded by windings, forces can be introduced into the coil 3 so that the coil is part of the carrying stator structure. The coil 3 may preferably be produced from a baking lacquer wire which, when being wound, results in an adhesive layer between the wire layers in order to achieve a higher level of pushing resistance between wires. This is not absolutely necessary since the clamping force of the coil already leads to a friction force between the individual coil layers.

The connection of the stator teeth 1 to each other is described below. The end face elements 6 at the self-supporting stator side are connected to each other by means of peripheral rings 5. These rings 5, owing to a corresponding structure, for example, a shaped collar 5a, have a high degree of strength. The connection to the end face elements 6 may be carried out by means of a weld spot 14 or by means of a positive-locking connection which is not described in greater detail. At the side with respect to the stator carrier 8, two additional rings 7a and 7b may be secured to the end face elements 2, preferably by means of a weld connection 13a and 13b. However, this is not absolutely necessary since the end face elements at this location are connected to the stator carrier 8, whereby the mutual connection of the stator teeth 1 is ensured.

The stator teeth 1 must be positioned in the stator carrier 8 in a precise manner. It is therefore recommended to fit positioning discs 9a and 9b to the stator carrier 8 which is produced, for example, from cast aluminium. In the stator carrier 8, there are turned grooves 8a and 8b in which the positioning discs 9a and 9b can be placed. The angular position relative to the stator carrier 8 is defined by means of a positioning pin 10. In the positioning discs 9a, 9b there are punched openings/recesses 9c in which the end face elements 2 can be inserted as far as the stop 2d thereof. The support elements are firmly connected to the positioning discs 9a and 9b by press-fit stemming and are consequently connected to the stator carrier. Alternatively, the end face elements 2 are also directly connected to the one on the stator carrier 8.

The stator structure described has advantages for the stator cooling. On the one hand, via the end face elements 2, the heat is directly introduced into the stator carrier 8 by means of thermal conduction. A cooling circuit which is not illustrated may be integrated therein. To this end, the end face elements 2 are preferably produced from materials which have a high level of thermal conductivity, such as aluminium or copper, but also steel. At the self-supporting stator side, the heat is directed by means of thermal conduction via the end face elements 6 into the peripheral ring 5. There, the heat can be discharged to the atmosphere 18 by means of convection and heat radiation.

FIG. 2 is a three-dimensional view, by means of which the stator structure is again illustrated.

List of reference numerals:

1 Stator tooth

1a, 1b External and internal pole shoe

1c End-face projection of the stator tooth 1

2 First end face element

2a Support face of the first end face element 2

2b Press-fit stemmings of the first end face element 2

2c Projection of the first end face element 2 which engages around the projection 1c

2d Side wall of the first end face element 2

3 Coil winding

4 Stator insulation

5 Peripheral ring at the self-supporting stator side

5a Shaped collar

6 Second end face element

6a Support face of the second end face element 6

6c Shaping of the second end face element 6

7a External peripheral ring

7b Internal peripheral ring

8 Stator carrier

8a, 8b Groove in the stator carrier

9a Inner positioning discs

9b Outer positioning discs

10 Positioning pin for positioning discs 9a, 9b

13a Connection of support element 1 to peripheral ring 7a

13b Connection of support element 1 to peripheral ring 7b

14 Connection of support element 2 to peripheral ring 5

16 External magnet of the external rotor

17 Internal magnet of the internal rotor

18 External rotor

19 Internal rotor

20 Stator

21 Base wall

1. An electric motor having:
a dual rotor; and
a hollow-cylindrical stator which carries exciter coils, the stator being connected at the end face to a stator carrier of the electric motor and having stator teeth which extend in an axial direction, and which each have at least one pole shoe, at least one coil winding being wound around a stator tooth in each case,
wherein there is arranged at one or both end faces of a stator tooth and/or the pole shoes of the stator tooth an end face element, which end face element or elements is/are at least partially wrapped or surrounded by the coil winding.

2. The electric motor according to claim 1, the end face element or elements is/are secured to the stator tooth and/or the pole shoes of the stator tooth by means of the coil winding.

3. The electric motor according to claim 1, wherein the stator tooth is secured to the stator carrier by means of a first end face element.

4. The electric motor according to claim 3, wherein a second end face element is arranged at an end face of the stator tooth facing away from the stator carrier, and further including an annular connection element arranged to connect the end face elements of the stator teeth.

5. The electric motor according to claim 1, wherein end face elements are arranged on all or only some stator teeth.

6. The electric motor according to claim 1, at least one wall region of an end face element is in abutment against the stator tooth or the at least one pole shoe of the stator tooth, the at least one wall region being surrounded by the at least one coil winding.

7. The electric motor according to claim 6, wherein the at least one wall region with which the end face element is in abutment against the stator tooth, has a shape adapted to an abutment face of the stator tooth.

8. The electric motor according to claim 1, wherein an end face element axially in a direction of the stator tooth, has at least one projection oriented in the direction of the stator tooth, wherein the at least one projection serves to enable the end face element to be supported on the stator tooth and/or to be engaged around the stator tooth or a region thereof, and is in abutment therewith.

9. The electric motor according to claim 1, wherein a first end face element is U-shaped, the first end face element being secured to the stator carrier by means of the two lateral members connected to each other by means of at least one wall region of the end face element.

10. The electric motor according to claim 8, wherein the at least one projection is secured to a wall region or a lateral member of the end face element.

11. The electric motor according to claim 1, wherein the at least one end face element is additionally connected to the stator tooth by means of bonding and/or welding.

12. The electric motor according to claim 3, wherein there are multiple first face elements associated with multiple stator teeth, and wherein the first end face elements are connected to each other by means of at least one ring and are connected to the ring by means of bonding or welding.

13. The electric motor according to claim 12, wherein the at least one ring is in abutment with the stator carrier and/or is connected to the stator carrier.

14. The electric motor according to claim 1, further having one or more annular discs inserted in openings or recesses of the stator carrier, wherein at least one of the end face elements is supported and/or secured by the one or more annular discs.

15. The electric motor according to claim 1, wherein the dual rotor has an external rotor and an internal rotor, the external and/or the internal rotor having permanent magnets, and wherein the stator is arranged radially between the external rotor and the internal rotor, and wherein a respective one of the stator teeth has an external pole shoe and an internal pole shoe.

16. The electric motor according to claim 1, wherein end face elements are arranged on more than one but less than all stator teeth.

17. The electric motor according to claim 16, wherein the end face elements are arranged on half of all the stator teeth or on every third stator tooth.
